(19) United States
(12) Patent Application Publication
(10) Pub. No.: US 2006/0242098 A1
(43) Pub. Date: Oct. 26, 2006

(54) Generating representative exemplars for indexing, clustering, categorization and taxonomy

(75) Inventor: Janusz Wnek, Germantown, MD (US)

Correspondence Address: STERNE, KESSLER, GOLDSTEIN & FOX PLLC, 1100 NEW YORK AVENUE, N.W., WASHINGTON, DC, 20005, US

(73) Assignee: Content Analyst Company, LLC, Reston, VA (US)

(21) Appl. No.: 11/262,735

(22) Filed: Nov. 1, 2005

Related U.S. Application Data
(60) Provisional application No. 60/674,706, filed on Apr. 26, 2005.

(51) Int. Cl. G06N 5/00; G06F 17/00

(52) U.S. Cl. 706/45

(57) ABSTRACT

A method for automatically selecting representative exemplars from a collection of documents. The method includes generating a representation of each document in the collection of documents in an abstract mathematical space, measuring a similarity between the representation of each document in the collection of documents and the representation of at least one other document in the collection of documents, identifying clusters of conceptually similar documents based on the similarity measurements, and identifying at least one exemplary document within each cluster.

### CROSS REFERENCE TO RELATED APPLICATIONS

This application claims benefit under 35 U.S.C. § 119(e) to U.S. Provisional Patent Application 60/674,706, entitled “Generating Representative Exemplars for Indexing, Clustering, Categorization, and Taxonomy,” to Wnek, filed on Apr. 26, 2005, the entirety of which is hereby incorporated by reference as if fully set forth herein.

### BACKGROUND OF THE INVENTION

1. Field of the Invention

The present invention is generally directed to the field of automated document processing.

2. Background

Information retrieval is of the utmost importance in the current Age of Information. One well-known approach for retrieving information is a keyword search. In accordance with a keyword search, a document is retrieved if the word(s) of a user's query explicitly appear in the document.

However, there are at least two problems with this approach. First, a keyword search will not retrieve information that is conceptually relevant to the user's query if the information does not contain the exact word(s) of the query. Second, a keyword search may retrieve information that is not conceptually relevant to the intended meaning of a user's query. This may occur because words often have multiple meanings or senses. For example, the word “tank” has a meaning associated with “a military vehicle” and a meaning associated with “a container.”

One method that can reduce the above-mentioned adverse effects associated with keyword searching is called Latent Semantic Indexing (LSI). LSI is described, for example, in a paper by Deerwester, et al. entitled, “Indexing by Latent Semantic Analysis,” which was published in Journal of the American Society For Information Science, vol. 41, pp. 391-407, the entirety of which is incorporated by reference herein. In LSI, each term and/or document from an indexed collection of documents is represented as a vector in an abstract mathematical vector space. Information retrieval is performed by representing the user's query as a vector in the same vector space, and then retrieving documents having vectors within a certain “proximity” of the query vector. The performance of LSI-based information retrieval far exceeds that of keyword searching because documents that are conceptually similar to the query are retrieved even when the query and the retrieved documents use different terms to describe similar concepts.

According to Deerwester et al., the orthogonal basis vectors (factors) of the abstract mathematical vector space generated by LSI represent the “artificial concepts” contained in the document collection. In practice, however, it is difficult to reconstruct easily comprehensible descriptions of the artificial concepts. In fact, Deerwester et al. “make no attempt to interpret the underlying factors.” In other words, although LSI provides a superior method for identifying conceptually-similar documents, it does not provide any method for rendering easily comprehensible descriptions of the concepts that underlie the similarity determination.

In addition, Deerwester et al. commented on the representational limitation of the LSI model, “we believe that the model of a Euclidean space is at best a useful approximation. In reality, conceptual relations among terms and documents certainly involve more complex structures, including, for example, local hierarchies and non-linear interactions between meanings.” Because the LSI technique uses only a fixed number of factors to represent the latent semantic space, it has the effect of internally merging some of the represented concepts. As a result, the LSI space may lose some of its expressive power.

Based on the foregoing, what is needed is a method for automatically selecting high utility representative documents, or exemplars, from a collection of documents. For example, such representative documents, when used in a query against the collection of documents, should extract a group of conceptually-similar documents of a non-trivial size.

### BRIEF SUMMARY OF THE INVENTION

The present invention provides a method for automatically selecting high utility seed exemplars from a collection of documents that can be used in a variety of document processing tasks, such as indexing, clustering, categorization and taxonomy. As selected representatives of clusters of similar documents, the seed exemplars represent pivotal concepts contained in the collection. The method is general and can be applied to any representation of documents with a similarity measure. An embodiment of the invention makes use of the Latent Semantic Indexing (LSI) and the cosine similarity measure.

In an embodiment of the present invention, there is provided a method for automatically selecting exemplary documents from a collection of documents. The method includes generating a representation of each document in the collection of documents in an abstract mathematical space, measuring a similarity between the representation of each document in the collection of documents and the representation of at least one other document in the collection of documents, identifying clusters of conceptually similar documents based on the similarity measurements, and identifying at least one exemplary document within each cluster.

An embodiment of the present invention provides several advantages and provides some unique capabilities and opportunities not previously available. For example, an embodiment of the present invention enables selection of high quality exemplars from a collection of documents. Each exemplary document represents an exemplary concept contained within the collection of documents. Thus, the extraction of exemplary documents in accordance with an embodiment of the present invention results in the extraction of exemplary concepts contained in the collection, thereby expanding the expressiveness of the underlying model.

In addition, the proposed method can reduce the complexity of searches for many data object processing related algorithms, such as data object indexing, clustering, categorization, and taxonomy. The reduction in the complexity can improve the performance of an algorithm designed to parse and interpret information included in a collection of data objects.

An embodiment of the present invention can be applied to different types of data objects including, but not limited to, documents, text data, image data, voice data, video data, structured data, unstructured data, and relational data.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a flowchart illustrating an example method for selecting exemplar documents from a collection of documents in accordance with an embodiment of the present invention.

FIGS. 2A, 2B and 2C jointly depict a flowchart of a method for automatically selecting high utility seed exemplars from a collection of documents in accordance with an embodiment of the present invention.

FIG. 3 depicts a flowchart of a method for obtaining a seed cluster for a document in accordance with an embodiment of the present invention.

FIGS. 4A, 4B, 4C, 4D and 4E present tables that graphically demonstrate the application of a method in accordance with an embodiment of the present invention to a collection of documents.

FIG. 5 is a block diagram of a computer system on which an embodiment of the present invention may be executed.

FIG. 6 geometrically illustrates a manner in which to measure the similarity between two documents in accordance with an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

A. Overview

The following describes an example method for generating high utility seed exemplars from a collection of documents in accordance with an embodiment of the present invention. The example method utilizes the Latent Semantic Indexing (LSI) representation of documents and its cosine similarity measure to find clusters of similar documents and select the most representative exemplars from the clusters. The LSI technique is well-known and its application is fully explained in commonly-owned U.S. Pat. No. 4,839,853 (“the '853 patent”) entitled “Computer Information Retrieval Using Latent Semantic Structure” to Deerwester et al., the entirety of which is incorporated by reference herein. The exemplars may then be used as a conceptual structure for the original collection and the documents in the original collection can be reorganized accordingly.

It should be noted, however, that the present invention is not limited to the use of the LSI technique. Rather, the method is general and can be implemented using any representation of documents with a similarity measure. Some examples of techniques other than LSI that can be used to generate a representation of documents in accordance with implementations of the present invention include, but are not limited to, the following: (i) probabilistic LSI (see, e.g., Hoffman, T., “Probabilistic Latent Semantic Indexing,” Proceedings of the 22^{nd} Annual SIGIR Conference, Berkeley, Calif., 1999, pp. 50-57); (ii) latent regression analysis (see, e.g., Marchisio, G., and Liang, J., “Experiments in Trilingual Cross-language Information Retrieval,” Proceedings, 2001 Symposium on Document Image Understanding Technology, Columbia, Md., 2001, pp. 169-178); (iii) LSI using semi-discrete decomposition (see, e.g., Kolda, T., and O. Leary, D., “A Semidiscrete Matrix Decomposition for Latent Semantic Indexing Information Retrieval,” ACM Transactions on Information Systems, Volume 16, Issue 4 (October 1998), pp. 322-346); and (iv) self-organizing maps (see, e.g., Kohonen, T., “Self-Organizing Maps,” 3^{rd} Edition, Springer-Verlag, Berlin, 2001). Each of the foregoing cited references is incorporated by reference in its entirety herein.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

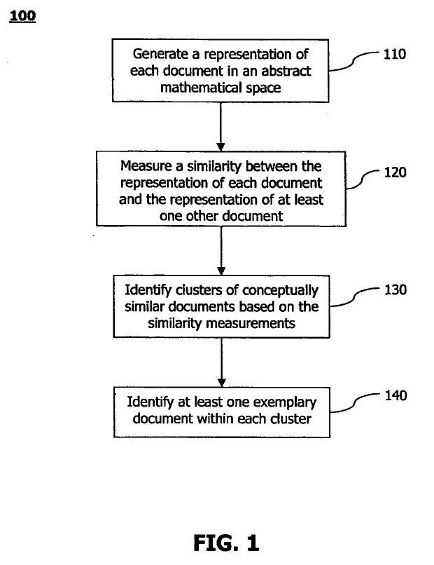

FIG. 1 illustrates a flowchart 100 of a general method for automatically selecting exemplary documents from a collection of documents in accordance with an embodiment of the present invention. The collection of documents can include a large number of documents, such as 100,000 documents or some other large number of documents. As was mentioned above, and as is described below, the exemplary documents can be used for generating an index, a cluster, a categorization, a taxonomy, or a hierarchy. In addition, selecting exemplary documents can reduce the number of documents needed to represent the conceptual content contained within a collection of document, which can facilitate the performance of other algorithms, such as an intelligent learning system.

Flowchart 100 begins at a step 110 in which each document in a collection of documents is represented in an abstract mathematical space. For example, each document can be represented as a vector in an LSI space as is described in detail in the '853 patent.

In a step 120, a similarity between the representation of each document and the representation of at least one other document is measured. In an embodiment in which the documents are represented in an LSI space, the similarity measurement can be a cosine measure.

FIG. 6 geometrically illustrates how the similarity between the representations can be determined. FIG. 6 illustrates a two-dimensional graph 600 including a vector representation for each of three documents, labeled D₁, D₂, and D₃. The vector representations are represented in FIG. 6 on two-dimensional graph 600 for illustrative purposes only, and not limitation. In fact, the actual number of dimensions used to represent a document or a pseudo-object in an LSI space can be on the order of a few hundred dimensions.

As shown in FIG. 6, an angle α₁₂ between D₁ and D₂ is greater than an angle α₂₃ between D₂ and D₃. Since angle α₂₃ is smaller than angle α₁₂, the cosine of α₂₃ will be larger than the cosine of α₁₂. Accordingly, in this example, the document represented by vector D₂ is more conceptually similar to the document represented by vector D₃ than it is to the document represented by vector D₁.

In a step 130, clusters of conceptually similar documents are identified based on the similarity measurements. For example, documents about golf can be included in a first cluster of documents and documents about space travel can be included in a second cluster of documents.

In a step 140, at least one exemplary document is identified for each cluster. In an embodiment, a single exemplary document is identified for each cluster. In an alternative embodiment, more than one exemplary document is identified for each cluster. As mentioned above, the exemplary documents represent exemplary concepts contained within the collection of documents. With respect to the example mentioned above, at least one document in the cluster of documents about golf would be identified as an exemplary document that represents the concept of golf. Similarly, at least one document in the cluster of documents about space travel would be identified as an exemplary document that represents the concept of space travel.

In an embodiment, the number of documents included in each cluster can be set based on a clustering threshold. The extent to which the exemplary documents span the conceptual content contained within the collection of documents can be adjusted by adjusting the clustering threshold. This point will be illustrated by an example.

If the clustering threshold is set to a relatively high level, such as four documents, each cluster identified in step 130 will include at least four documents. Then in step 140, at least one of the at least four documents will be identified as the exemplary document(s) that represent(s) the conceptual content of that cluster. For example, all the documents in this cluster could be about golf. In this example, all the documents in the collection of documents that are conceptually similar to golf, up to a threshold, are included in this cluster; and at least one of the documents in this cluster, the exemplary document, exemplifies the concept of golf contained in all the documents in the cluster. In other words, with respect to the entire collection of documents, the concept of golf is represented by the at least one exemplary document identified for this cluster.

If, on the other hand, there is one document in the collection of documents that is about space travel, by setting the clustering threshold to the relatively high value, the concept of space travel will not be represented by any exemplary document. That is, if the clustering threshold is set to four, no cluster including at least four documents that are each about space travel will be identified because there is only one document that is about space travel. Since a cluster is not identified for space travel, an exemplary document that represents the concept of space travel will not be identified.

However, in this example, the concept of space travel could be represented by an exemplary document if the clustering threshold was set to a relatively low value—i.e., one. By setting the clustering threshold to one, the document about space travel would be identified in a cluster that included one document. Then, the document about space travel would be identified as the exemplary document in the collection of documents that represents the concept of space travel.

To summarize, by setting the clustering threshold relatively high, major concepts contained within the collection of documents will be represented by an exemplary document. From the example above, by setting the clustering threshold to four, the concept of golf would be represented by an exemplary document, but the concept of space travel would not. Alternatively, by setting the clustering threshold relatively low, all concepts contained within the collection of documents would be represented by an exemplary document. From the example above, by setting the clustering threshold to one, each of the concepts of golf and space travel would respectively be represented by an exemplary document.

By identifying exemplary documents, the number of documents needed to cover the conceptual content of the collection of documents can be reduced, without compromising a desired extent to which the conceptual content is covered. The number of documents in a collection of documents could be very large. For example, the collection of documents could include 100, 10,000, 1,000,000 or some other large number of documents. Processing and/or storing such a large number of documents can be cumbersome, inefficient, and/or impossible. Often it would be helpful to reduce this number of documents without losing the conceptual content contained within the collection of documents. Because the exemplary documents identified in step 140 above represent at least the major conceptual content of the entire collection of document, these exemplary documents can be used as proxies for the conceptual content of the entire collection of documents. In addition, the clustering threshold can be adjusted so that the exemplary documents span the conceptual content of the collection of documents to a desired extent. For example, using embodiments described herein, 5,000 exemplary documents could be identified that collectively represent the conceptual content contained in a collection of 100,000 documents. In this way, the complexity required to represent the conceptual content contained in the 100,000 documents is reduced by 95%.

As mentioned above, the exemplary documents can be used, for example, to generate (i) non-intersecting clusters of conceptually similar documents, and/or (ii) a taxonomy of concepts contained in the collection of documents. The clusters identified in step 130 of flowchart 100 are not necessarily non-intersecting. For example, a first cluster of documents can include a subset of documents about golf and a second cluster of documents may also include this same subset of documents about golf. In this example, as noted in item (i), the exemplary document for the first collection of documents and the exemplary document for the second collection of documents can be used to generate non-intersecting clusters. For instance, the generation of non-intersecting clusters can be based on at least two criteria: cohesiveness and coverage. Cohesiveness refers to the extent that each document in a cluster is conceptually similar to an exemplary document of that cluster. Coverage refers to the number of documents included in a cluster. By generating non-intersecting clusters, only one cluster would include the subset of documents about golf.

With respect to item (ii) from above, since the exemplary documents represent concepts contained within the collection of documents, candidate terms can be extracted from the exemplary documents and used to generate a taxonomy of the concepts that are contained within the collection of documents. For example, terms that appear most frequently in an exemplary document or terms that are most conceptually similar to a central concept of that exemplary document can be selected as candidate terms. The conceptual similarity of each term in the exemplary document with respect to the central concept of the exemplary document can be measured using a cosine similarity measure described herein or some other similarity measure as would be apparent to a person skilled in the relevant art(s).

In addition, one or more exemplary documents can be merged into a single exemplary object that better represents a single concept contained in the collection of documents.

As mentioned above, the foregoing example embodiment can also be applied to data objects other than, but including, documents. Such data objects include, but are not limited to, documents, text data, image data, video data, voice data, structured data, unstructured data, relational data, and other forms of data as would be apparent to a person skilled in the relevant art(s).

B. Example Method for Automatic Selection of Seed Exemplars in Accordance with an Embodiment of the Present Invention

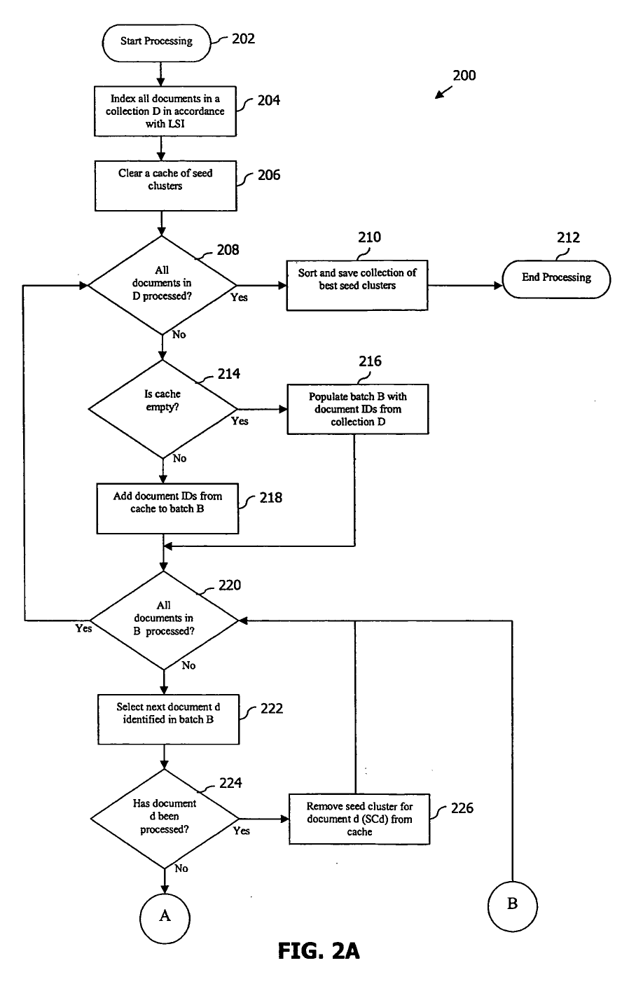

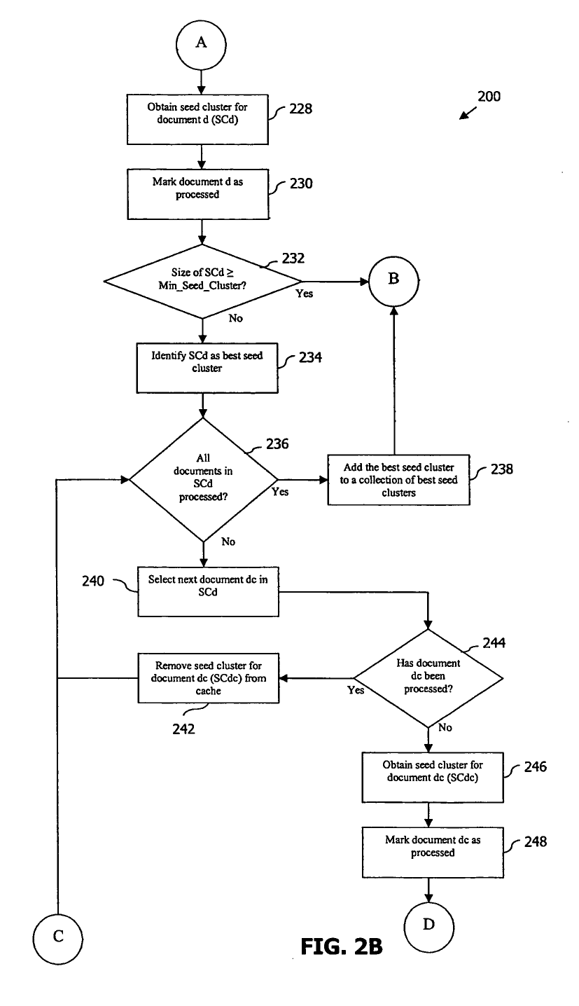

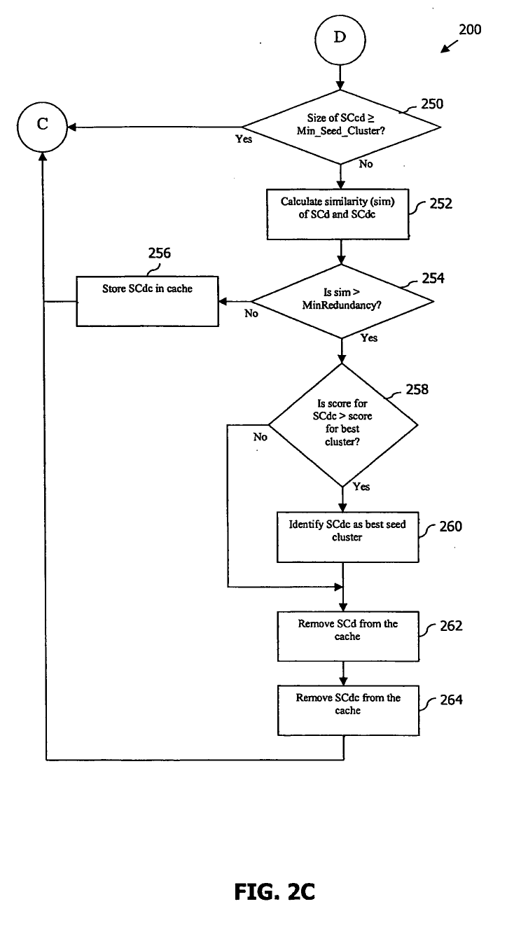

An example method for automatically selecting seed exemplars in accordance with an embodiment of the present invention is depicted in a flowchart 200, which is illustrated in FIGS. 2A, 2B and 2C. Generally speaking, the example method operates on a collection of documents, each of which is indexed and has a vector representation in the LSI space. The documents are examined and tested as candidates for cluster seeds. The processing is performed in batches to limit the use of available memory. Each document is used to create a candidate seed cluster at most one time and cached, if necessary. The seed clusters are cached because cluster creation requires matching the document vector to all document vectors in the repository and selecting those that are similar above a predetermined similarity threshold. In order to further prevent unnecessary testing, cluster construction is not performed for duplicate documents or almost identical documents.

The method of flowchart 200 will now be described in detail. As shown in FIG. 2A, the method is initiated at step 202 and immediately proceeds to step 204. At step 204, all documents in a collection of documents D are indexed in accordance with the LSI technique and are assigned a vector representation in the LSI space. As mentioned above, the LSI technique is described in the '853 patent. Alternatively, the collection of documents may be indexed using the LSI technique prior to application of the present method. In this case, step 204 may merely involve opening or otherwise accessing the stored collection of documents D. In either case, each document in the collection D is associated with a unique document identifier (ID).

The method then proceeds to step 206, in which a cache used for storing seed clusters is cleared in preparation for use in subsequent processing steps.

At step 208, a determination is made as to whether all documents in the collection D have already been processed. If all documents have been processed, the method proceeds to step 210, in which the highest quality seed clusters identified by the method are sorted and saved. Sorting may be carried out based on the size of the seed clusters or based on a score associated with each seed cluster that indicates both the size of the cluster and the similarity of the documents within the cluster. However, these examples are not intended to be limiting and other methods of sorting the seed clusters may be used. Once the seed clusters have been sorted and saved, the method ends as shown at step 212.

However, if it is determined at step 208 that there are documents remaining to be processed in document collection D, the method proceeds to step 214. At step 214, it is determined whether the cache of document IDs is empty. As noted above, the method of flowchart 200 performs processing in batches to limit the use of available memory. If the cache is empty, the batch B is populated with document IDs from the collection of documents D, as shown at step 216. However, if cache is not empty, document IDs of those documents associated with seed clusters currently stored in the cache are added to batch B, as shown at step 218.

At step 220, it is determined whether all the documents identified in batch B have been processed. If all the documents identified in batch B have been processed, the method returns to step 208. Otherwise, the method proceeds to step 222, in which a next document d identified in batch B is selected. At step 224, it is determined whether document d has been previously processed. If document d has been processed, then any seed cluster for document d stored in the cache is removed as shown at step 226 and the method returns to step 220.

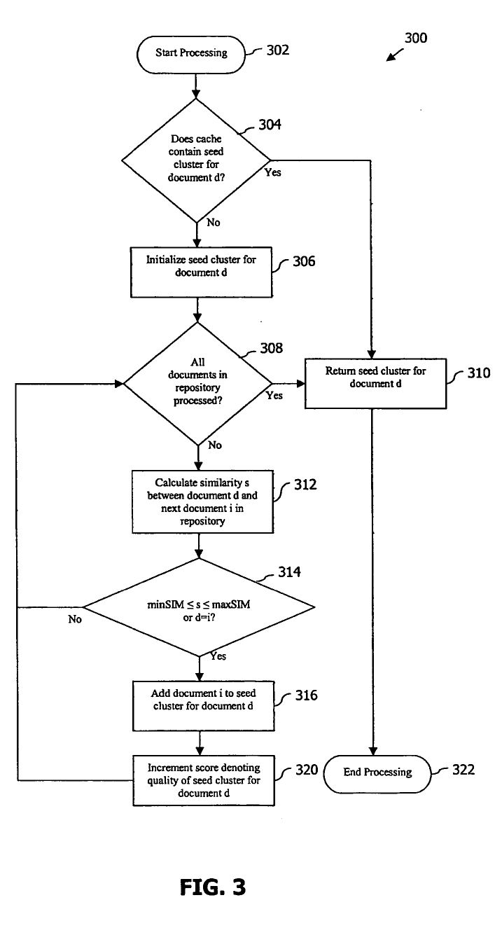

However, if document d has not been processed, then a seed cluster for document d, denoted SCd, is obtained as shown at step 228. One method for obtaining a seed cluster for a document will be described in more detail herein with reference to flowchart 300 of FIG. 3. A seed cluster may be represented as a data structure that includes the document ID for the document for which the seed cluster is obtained, the set of all documents in the cluster, and a score indicating the quality of the seed cluster. In an embodiment, the score indicates both the size of the cluster and the overall level of similarity between documents in the cluster.

After the seed cluster SCd has been obtained, the document d is marked as processed as shown at step 230.

At step 232, the size of the cluster SCd (i.e., the number of documents in the cluster) is compared to a predetermined minimum cluster size, denoted Min_Seed_Cluster. If the size of the cluster SCd is less than Min_Seed_Cluster, then the document d is essentially ignored and the method returns to step 220. By comparing the cluster size of SCd to a predetermined minimum cluster size in this manner, an embodiment of the present invention has the effect of weeding out those documents in collection D that generate very small seed clusters. In practice, it has been observed that setting Min_Seed_Cluster=4 provides satisfactory results.

If, on the other hand, SCd is of at least Min_Seed_Cluster size, then the method proceeds to step 234, in which SCd is identified as the best seed cluster. The method then proceeds to a series of steps that effectively determine whether any document in the cluster SCd provides better quality clustering than document d in the same general concept space.

In particular, at step 236, it is determined whether all documents in the cluster SCd have been processed. If all documents in cluster SCd have been processed, the currently-identified best seed cluster is added to a collection of best seed clusters as shown at step 238, after which the method returns to step 220.

If all documents in SCd have not been processed, then a next document dc in cluster SCd is selected. At step 244, it is determined whether document dc has been previously processed. If document dc has already been processed, then any seed cluster for document dc stored in the cache is removed as shown at step 242 and the method returns to step 236.

If, on the other hand, document dc has not been processed, then a seed cluster for document dc, denoted SCdc, is obtained as shown at step 246. As noted above, one method for obtaining a seed cluster for a document will be described in more detail herein with reference to flowchart 300 of FIG. 3. After the seed cluster SCdc has been obtained, the document dc is marked as processed as shown at step 248.

At step 250, the size of the cluster SCdc (i.e., the number of documents in the cluster) is compared to the predetermined minimum cluster size, denoted Min_Seed_Cluster. If the size of the cluster SCdc is less than Min_Seed_Cluster, then the document dc is essentially ignored and the method returns to step 236.

If, on the other hand, SCd is greater than or equal to Min_Seed_Cluster, then the method proceeds to step 252, in which a measure of similarity (denoted sim) is calculated between the clusters SCd and SCdc. In an embodiment, a cosine measure of similarity is used, although the invention is not so limited. Persons skilled in the relevant art(s) will readily appreciate that other similarity metrics may be used.

At step 254, the similarity measurement calculated in step 252 is compared to a predefined minimum redundancy, denoted MinRedundancy. If the similarity measurement does not exceed MinRedundancy, then it is determined that SCdc is sufficiently dissimilar from SCd that it might represent a sufficiently different concept. As such, SCdc is stored in the cache as shown at step 256 for further processing and the method returns to step 236.

The comparison of sim to MinRedundancy is essentially a test for detecting redundant seeds. This is an important test in terms of reducing the complexity of the method and thus rendering its implementation more practical. Complexity may be even further reduced if redundancy is determined based on the similarity of the of the seeds themselves, an implementation of which is described below. Once two seeds are deemed redundant, the seeds quality can be compared. In an embodiment of the present invention, the sum of all similarity measures between the seed document and its cluster documents is used to represent the seed quality. However, there may be other methods for determining quality of a cluster.

If the similarity measurement calculated in step 252 does exceed MinRedundancy, then the method proceeds to step 258, in which a score denoting the quality of cluster SCdc is compared to a score associated with the currently-identified best seed cluster. As noted above, the score may indicate both the size of a cluster and the overall level of similarity between documents in the cluster. If the score associated with SCdc exceeds the score associated with the best seed cluster, then SCdc becomes the best seed cluster, as indicated at step 260. In either case, after this comparison occurs, seed clusters SCd and SCdc are removed from the cache as indicated at steps 262 and 264. Processing then returns to step 236.

Note that when a document dc is discovered in cluster SCd that provides better clustering, instead of continuing to loop through the remaining documents in SCd in accordance with the logic beginning at step 236 of flowchart 200, an alternate embodiment of the present invention would instead begin to loop through the documents in the seed cluster associated with document dc (SCdc) to identify a seed document that provides better clustering. To achieve this, the processing loop beginning at step 236 would essentially need to be modified to loop through all documents in the currently-identified best seed cluster, rather than to loop through all documents in cluster SCd. Persons skilled in the relevant art(s) will readily appreciate how to achieve such an implementation based on the teachings provided herein.

In another alternative embodiment of the present invention, the logic beginning at step 236 that determines whether any document in the cluster SCd provides better quality clustering than document d in the space of equivalent concepts, or provides a quality cluster in a sufficiently dissimilar concept space, is removed. In accordance with this alternative embodiment, the seed clusters identified as best clusters in step 234 are simply added to the collection of best seed clusters and then sorted and saved when all documents in collection D have been processed. All documents in the SCd seed clusters are marked as processed—in other words, they are deemed redundant to the document d. This technique is more efficient than the method of flowchart 200, and is therefore particularly useful when dealing with very large document databases.

FIG. 3 depicts a flowchart 300 of a method for obtaining a seed cluster for a document d in accordance with an embodiment of the present invention. This method may be used to implement steps 228 and 246 of flowchart 200 as described above in reference to FIG. 2. For the purposes of describing flowchart 300, it will be assumed that a seed cluster is represented as a data structure that includes a document ID for the document for which the seed cluster is obtained, the set of all documents in the cluster, and a score indicating the quality of the seed cluster. In an embodiment, the score indicates both the size of the cluster and the overall level of similarity between documents in the cluster.

As shown in FIG. 3, the method of flowchart 300 is initiated at step 302 and immediately proceeds to step 304, in which it is determined whether a cache already includes a seed cluster for a given document d. If the cache includes the seed cluster for document d, it is returned as shown at step 310, and the method is then terminated as shown at step 322.

If the cache does not include a seed cluster for document d, then the method proceeds to step 306, in which a seed cluster for document d is initialized. For example, in an embodiment, this step may involve initializing a seed cluster data structure by emptying a set of documents associated with the seed cluster and moving zero to a score indicating the quality of the seed cluster.

The method then proceeds to step 308 in which it is determined whether all documents in a document repository have been processed. If all documents have been processed, it is assumed that the building of the seed cluster for document d is complete. Accordingly, the method proceeds to step 310 in which the seed cluster for document d is returned, and the method is then terminated as shown at step 322.

If, however, all documents in the repository have not been processed, then the method proceeds to step 312, in which a measure of similarity (denoted s) is calculated between document d and a next document i in the repository. In an embodiment, s is calculated by applying a cosine similarity measure to a vector representation of the documents, such as an LSI representation of the documents, although the invention is not so limited.

At step 314, it is determined whether s is greater than or equal to a predefined minimum similarity measurement, denoted minSIM, and less than or equal to a predefined maximum similarity measurement, denoted maxSIM, or if the document d is in fact equal to the document i. The comparison to minSIM is intended to filter out documents that are conceptually dissimilar from document d from the seed cluster. In contrast, the comparison to maxSIM is intended to filter out documents that are duplicates of, or almost identical to, document d from the seed cluster, thereby avoiding unnecessary testing of such documents as candidate seeds, i.e., steps starting from step 246. In practice, it has been observed that setting minSIM to a value in the range of 0.35 to 0.40 and setting maxSIM to 0.99 produces satisfactory results, although the invention is not so limited. Furthermore, testing for the condition of d=i is intended to ensure that document d is included within its own seed cluster.

If the conditions of step 314 are not met, then document i is not included in the seed cluster for document d and processing returns to step 308. If, on the other hand, the conditions of step 314 are met, then document i is added to the set of documents associated with the seed cluster for document d as shown at step 316 and a score is incremented that represents the quality of the seed cluster for document d as shown at step 320. In an embodiment, the score is incremented by the cosine measurement of similarity between document d and i, although the invention is not so limited. After step 320, the method returns to step 308.

It is noted that the above-described methods depend on a representation of documents and a similarity measure to compare documents. Therefore, any system that uses a representation space with a similarity measure could be used to find exemplary seeds using the algorithm.

C. Example Application of a Method in Accordance with An Embodiment of the Present Invention

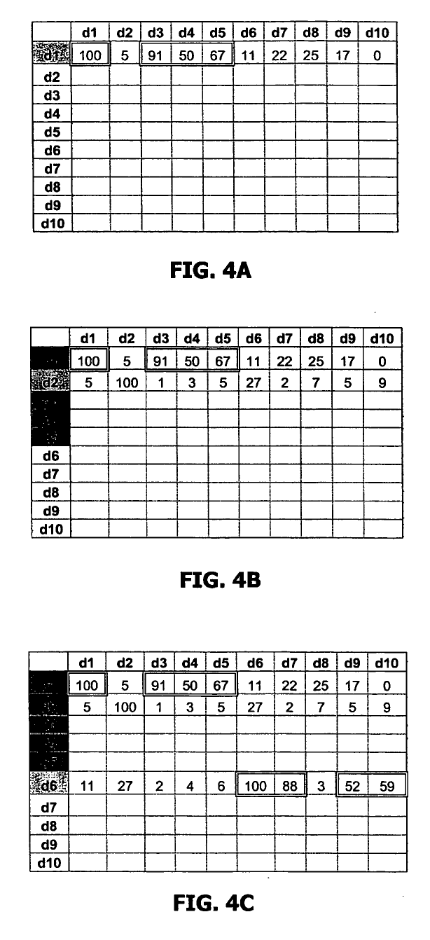

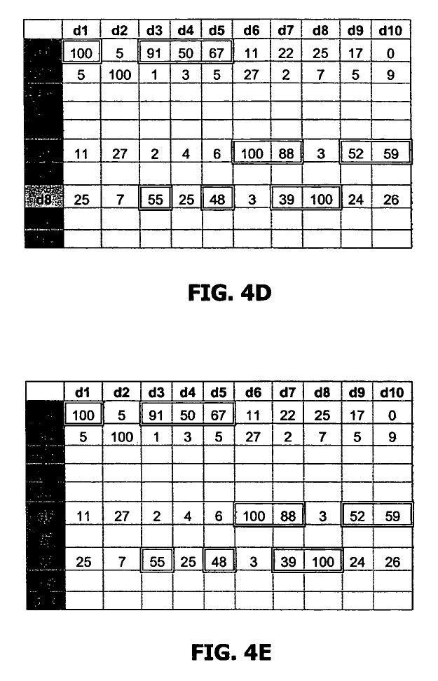

FIGS. 4A, 4B, 4C, 4D and 4E present tables that graphically demonstrate, in chronological order, the application of a method in accordance with an embodiment of the present invention to a collection of documents d1-d10. Note that these tables are provided for illustrative purposes only and are not intended to limit the present invention. In FIGS. 4A-4E, an unprocessed document is indicated by a white cell, a document being currently processed is indicated by a light gray cell, while a document that has already been processed is indicated by a dark gray cell. Documents that are identified as being part of a valid seed cluster are encompassed by a double-lined border.

FIG. 4A shows the creation of a seed cluster for document d1. As shown in that figure, document d1 is currently being processed and a value denoting the measured similarity between document d1 and each of documents d1-d10 has been calculated (not surprisingly, d1 has 100% similarity with itself). In accordance with this example, a valid seed cluster is identified if there are four or more documents that provide a similarity measurement in excess of 0.35 (or 35%). In FIG. 4A, it can be seen that there are four documents that have a similarity to document d1 that exceeds 35%—namely, documents d1, d3, d4 and d5. Thus, these documents are identified as forming a valid seed cluster.

In FIG. 4B, the seed cluster for document d1 remains marked and document d2 is now currently processed. Documents d1, d3, d4 and d5 are now shown as processed, since each of these documents were identified as part of the seed cluster for document d1. In accordance with this example method, since documents d1, d3, d4 and d5 have already been processed, they will not be processed to identify new seed clusters. Note that in an alternate embodiment described above in reference to FIGS. 2A-2C, additional processing of documents d3, d4 and d5 may be performed to see if any of these documents provide for better clustering than d1.

As further shown in FIG. 4B, a value denoting the measured similarity between document d2 and each of documents d1-d10 is calculated. However, only the comparison of document d2 to itself provides a similarity measure greater than 35%. As a result, in accordance with this method, no valid seed cluster is identified for document d2.

In FIG. 4C, documents d1-d5 are now shown as processed and document d6 is currently being processed. The comparison of document d6 to documents d1-d10 yields four documents having a similarity measure that exceeds 35%—namely, documents d6, d7, d9 and d10. Thus, in accordance with this method, these documents are identified as a second valid seed cluster. As shown in FIG. 4D, based on the identification of a seed cluster for document d6, each of documents d6, d7, d9 and d10 are now marked as processed and the only remaining unprocessed document, d8, is processed.

The comparison of d8 to documents d1-d10 yields four documents having a similarity measure to d8 that exceeds 35%. As a result, documents d3, d5, d7 and d8 are identified as a third valid seed cluster as shown in FIG. 4D. As shown in FIG. 4E, all documents d1-d10 have now been processed and three valid seed clusters around representative documents d1, d6 and d8 have been identified.

The method illustrated by FIGS. 4A-4E may significantly reduce a search space, since some unnecessary testing is skipped. In other words, the method utilizes heuristics based on similarity between documents to avoid some of the document-to-document comparisons. Specifically, in the example illustrated by these figures, out of ten documents, only four are actually compared to all the other documents. Other heuristics may be used, and some are set forth above in reference to the methods of FIGS. 2A-2C and FIG. 3 and in the pseudo-code examples set forth below.

D. Pseudo-Code Representation of an Algorithm in Accordance with an Embodiment of the Present Invention

The following is a pseudo-code representation of a cluster seeds generator algorithm in accordance with an embodiment of the present invention:

```
// For the collection of documents generate seed exemplars.
//
1.  open collection (D) of all documents in the repository indexed by LSI
2.  cluster cache [symbol] empty
3.  repeat
4.  if cache is empty then get a batch of document ids (B) from the
    collection D
5.  else add document ids from the cache to batch (B)
6.  for all documents (d) in the batch (B) do
7.  if document d already processed then remove SCd from cache
8.  SCd [symbol] GetSeedClusterWithCache(d)
9.  mark document (d) as processed
10.  if the size of seed cluster (SCd) is smaller than
      Min_Seed_Cluster
      then continue processing (B)
11.  bestSeed [symbol] d
12.  bestScore [symbol] score(SCd)
13.  for all not processed documents (dc) in the seed cluster (SCd) do
14.  if document dc already processed then remove SCdc from
        cache
15.  SCdc [symbol] GetSeedClusterWithCache(dc)
16.  mark document (dc) as processed
17.  if the size of seed cluster (SCdc) is smaller than
        Min_Seed_Cluster then continue processing (SCd)
18.  calculate similarity: sim [symbol] cos (SCd, SCdc)
19.  if (sim > MinRedundancy) then // d and dc are redundant
20.  if (score(SCdc) > bestScore) then
21.  bestSeed [symbol] dc
22.  bestScore [symbol] score(SCdc)
23.  end if
24.  remove SCd from cache
25.  remove SCdc from cache
26.  continue processing SCd
27.  end if
28.  cache SCdc
29.  end for
30.  add bestSeed to the collection of best seeds
31.  end for
32. until all documents in collection D processed
33. sort documents according to score
34. save the collection of best seeds
```

The following is an example data structure for a seed cluster in accordance with an embodiment of the present invention:

| | |
|---|---|
| 1. class SCluster | |
| 2. long docid | // Document for which the cluster is created |
| 3. double score | // Cluster quality |
| 4. Set cluster | // Set of documents in the cluster |

5. SCluster(d, sc, cl)
6. docid [symbol] d
7. score [symbol] sc
8. cluster [symbol] cl
9. end class

The following is a pseudo-code representation of a method for obtaining a seed cluster for a document d in accordance with an embodiment of the present invention:

// For the given document d create a cluster of documents that are similar
to d.
// Calculate cluster quality.

| | |
|---|---|
| 1. | if cache contains seed cluster for document (d) then return cache(d) |
| 2. | cluster [symbol] empty |
| 3. | score [symbol] 0 |
| 4. | for all documents (i) in the repository do |
| 5. | if (minSIM <= cos(d, i) <= maxSIM or d=i) then |
| 6. | add document i to cluster |
| 7. | score [symbol] score + cos(d, i) |
| 8. | end if |
| 9. | end for |
| 10. | return new SCluster(d, score, cluster) |

E. Example Computer System Implementation

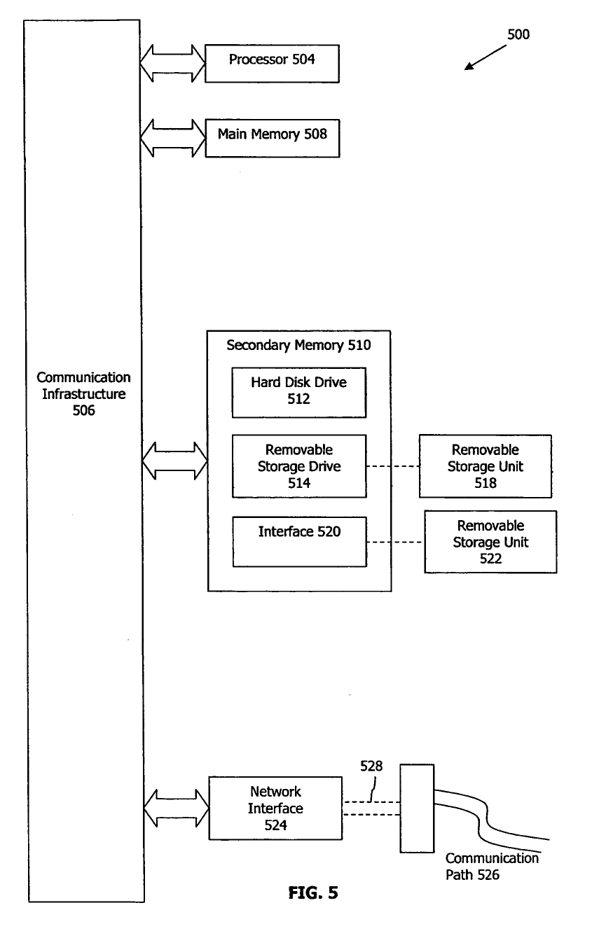

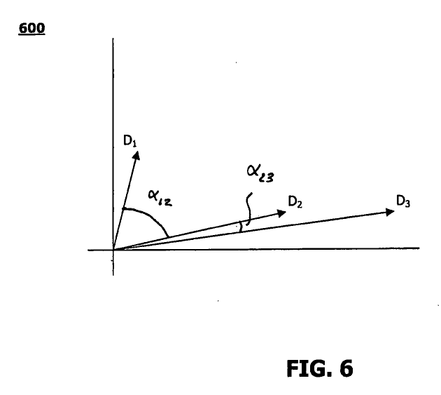

Various aspects of the present invention can be implemented by software, firmware, hardware, or a combination thereof. FIG. 5 illustrates an example computer system 500 in which an embodiment of the present invention, or portions thereof, can be implemented as computer-readable code. For example, the methods illustrated by flowchart 100 of FIG. 1, flowchart 200 of FIGS. 2A, 2B and 2C, and flowchart 300 of FIG. 3 can be implemented in system 500. Various embodiments of the invention are described in terms of this example computer system 500. After reading this description, it will become apparent to a person skilled in the relevant art how to implement the invention using other computer systems and/or computer architectures.

Computer system 500 includes one or more processors, such as processor 504. Processor 504 can be a special purpose or a general purpose processor. Processor 504 is connected to a communication infrastructure 506 (for example, a bus or network).

Computer system 500 also includes a main memory 508, preferably random access memory (RAM), and may also include a secondary memory 510. Secondary memory 510 may include, for example, a hard disk drive 512 and/or a removable storage drive 514. Removable storage drive 514 may comprise a floppy disk drive, a magnetic tape drive, an optical disk drive, a flash memory, or the like. The removable storage drive 514 reads from and/or writes to a removable storage unit 518 in a well known manner. Removable storage unit 518 may comprise a floppy disk, magnetic tape, optical disk, etc. which is read by and written to by removable storage drive 514. As will be appreciated by persons skilled in the relevant art(s), removable storage unit 518 includes a computer usable storage medium having stored therein computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to computer system 500.

Computer system 500 may also include a communications interface 524. Communications interface 524 allows software and data to be transferred between computer system 500 and external devices. Communications interface 524 may include a modem, a network interface (such as an Ethernet card), a communications port, a PCMCIA slot and card, or the like. Software and data transferred via communications interface 524 are in the form of signals 528 which may be electronic, electromagnetic, optical, or other signals capable of being received by communications interface 524. These signals 528 are provided to communications interface 524 via a communications path 526. Communications path 526 carries signals 528 and may be implemented using wire or cable, fiber optics, a phone line, a cellular phone link, an RF link or other communications channels.

In this document, the terms “computer program medium” and “computer usable medium” are used to generally refer to media such as removable storage unit 518, removable storage unit 522, a hard disk installed in hard disk drive 512, and signals 528. Computer program medium and computer usable medium can also refer to memories, such as main memory 508 and secondary memory 510, which can be memory semiconductors (e.g. DRAMs, etc.). These computer program products are means for providing software to computer system 500.

Computer programs (also called computer control logic) are stored in main memory 508 and/or secondary memory 510. Computer programs may also be received via communications interface 524. Such computer programs, when executed, enable computer system 500 to implement the present invention as discussed herein. In particular, the computer programs, when executed, enable processor 504 to implement the processes of the present invention, such as the steps in the methods illustrated by flowchart 100 of FIG. 1, flowchart 200 of FIG. 2, and flowchart 300 of FIG. 3 discussed above. Accordingly, such computer programs represent controllers of the computer system 500. Where the invention is implemented using software, the software may be stored in a computer program product and loaded into computer system 500 using removable storage drive 514, interface 520, hard drive 512 or communications interface 524.

The invention is also directed to computer products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

F. Example Capabilities and Applications

The embodiments of the present invention described herein have many capabilities and applications. The following example capabilities and applications are described below: monitoring capabilities; categorization capabilities; output, display and/or deliverable capabilities; and applications in specific industries or technologies. These examples are presented by way of illustration, and not limitation. Other capabilities and applications, as would be apparent to a person having ordinary skill in the relevant art(s) from the description contained herein, are contemplated within the scope and spirit of the present invention.

Monitoring Capabilities. As mentioned above, embodiments of the present invention can be used to monitor different media outlets to identify an item and/or information of interest. The item and/or information can be identified based on a similarity measure between an exemplary document that represents the item and/or information and a query (such as, a user-defined query). By way of illustration, and not limitation, the item and/or information of interest can include, a particular brand of a good, a competitor's product, a competitor's use of a registered trademark, a technical development, a security issue or issues, and/or other types of items either tangible or intangible that may be of interest. The types of media outlets that can be monitored can include, but are not limited to, email, chat rooms, blogs, web-feeds, websites, magazines, newspapers, and other forms of media in which information is displayed, printed, published, posted and/or periodically updated.

Information gleaned from monitoring the media outlets can be used in several different ways. For instance, the information can be used to determine popular sentiment regarding a past or future event. As an example, media outlets could be monitored to track popular sentiment about a political issue. This information could be used, for example, to plan an election campaign strategy.

Categorization Capabilities. As mentioned above, the exemplary documents identified in accordance with an embodiment of the present invention can also be used to generate a categorization of items. Example applications in which embodiments of the present invention can be coupled with categorization capabilities can include, but are not limited to, employee recruitment (for example, by matching resumes to job descriptions), customer relationship management (for example, by characterizing customer inputs and/or monitoring history), call center applications (for example, by working for the IRS to help people find tax publications that answer their questions), opinion research (for example, by categorizing answers to open-ended survey questions), dating services (for example, by matching potential couples according to a set of criteria), and similar categorization-type applications.

Output, Display and/or Deliverable Capabilities. Exemplary documents identified in accordance with an embodiment of the present invention and/or products that use exemplary documents identified in accordance with an embodiment of the present invention can be output, displayed and/or delivered in many different manners. Example outputs, displays and/or deliverable capabilities can include, but are not limited to, an alert (which could be emailed to a user), a map (which could be color coordinated), an unordered list, an ordinal list, a cardinal list, cross-lingual outputs, and/or other types of output as would be apparent to a person having ordinary skill in the relevant art(s) from reading the description contained herein.

Applications in Technology, Intellectual Property and Pharmaceuticals Industries. The identification of exemplary documents described herein, and their utility in generating an index, categorization, a taxonomy, or the like, can be used in several different industries, such as the Technology, Intellectual Property (IP) and Pharmaceuticals industries. Example applications of embodiments of the present invention can include, but are not limited to, prior art searches, patent/application alerting, research management (for example, by identifying patents and/or papers that are most relevant to a research project before investing in research and development), clinical trials data analysis (for example, by analyzing large amount of text generated in clinical trials), and/or similar types of industry applications.

H. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for automatically selecting exemplary documents from a collection of documents, comprising:
generating a representation of each document in the collection of documents in an abstract mathematical space;
measuring a similarity between the representation of each document in the collection of documents and the representation of at least one other document in the collection of documents;
identifying clusters of conceptually similar documents based on the similarity measurements; and
identifying at least one exemplary document within each cluster.

2. The method of claim 1, wherein generating a representation of each document in an abstract mathematical space comprises generating a vector representation of each document in a Latent Semantic Indexing (LSI) space.

3. The method of claim 2, wherein measuring a similarity between the vector representation of each document in the collection of documents and the vector representation of at least one other document in the collection of documents comprises applying a cosine similarity measure.

4. The method of claim 1, wherein identifying clusters of conceptually similar documents based on the similarity measurements comprises:
(a) identifying a first document in the collection of documents;
(b) identifying a first subset of documents in the collection of documents, wherein each document in the first subset meets a similarity criterion with the first document, and wherein the similarity criterion is based on the similarity measurements; and
(c) identifying a first cluster of conceptually similar documents associated with the first document if the number of documents in the first subset is at least a minimum number.

5. The method of claim 4, wherein identifying at least one exemplary document within each cluster comprises:
identifying the first document as an exemplary document within the first cluster of conceptually similar documents.

6. The method of claim 4, further comprising:
(d) identifying a second document in the first subset of documents;
(e) identifying a second subset of documents in the collection of documents, wherein each document in the second subset meets a similarity criterion with the second document, and wherein the similarity criterion is based on the similarity measurements; and
(f) identifying a second cluster of conceptually similar documents associated with the second document if the number of documents in the second subset is at least the minimum number.

7. The method of claim 6, wherein identifying at least one exemplary document within each cluster comprises identifying one exemplary document, the identification of the one exemplary document comprising:
assigning a score to the first cluster of conceptually similar documents associated with the first document and a score to the second cluster of conceptually similar documents associated with the second document; and
identifying one of the first and second documents as the one exemplary document in the cluster based on the assigned scores.

8. The method of claim 4, further comprising:
(d) identifying a second document in the collection of documents that is not associated with a cluster of conceptually similar documents;
(e) identifying a second subset of documents in the collection of documents, wherein each document in the second subset meets a similarity criterion with the second document, and wherein the similarity criterion is based on the similarity measurements; and
(f) identifying a second cluster of conceptually similar documents associated with the second document if the number of documents in the second subset is at least a minimum number.

9. A computer program product for automatically selecting exemplary documents from a collection of documents, comprising:
a computer usable medium having computer readable program code means embodied in said medium for causing an application program to execute on an operating system of a computer, said computer readable program code means comprising:
a computer readable first program code means for generating a representation of each document in the collection of documents in an abstract mathematical space;
a computer readable second program code means for measuring a similarity between the representation of each document in the collection of documents and the representation of at least one other document in the collection of documents;
a computer readable third program code means for identifying clusters of conceptually similar documents based on the similarity measurements; and
a computer readable fourth program code means for identifying at least one exemplary document within each cluster.

10. The computer program product of claim 9, wherein the computer readable first program code means comprises:
means for generating a vector representation of each document in a Latent Semantic Indexing (LSI) space.

11. The computer program product of claim 10, wherein the computer readable second program code means comprises:
means for applying a cosine similarity measure.

12. The computer program product of claim 9, wherein the computer readable third program code means for identifying clusters of conceptually similar documents based on the similarity measurements comprises:
means for identifying a first document in the collection of documents;
means for identifying a first subset of documents in the collection of documents, wherein each document in the first subset meets a similarity criterion with the first document, and wherein the similarity criterion is based on the similarity measurements; and
means for identifying a first cluster of conceptually similar documents associated with the first document if the number of documents in the first subset is at least a minimum number.

13. The computer program product of claim 12, wherein the computer readable fourth program code means for identifying at least one exemplary document within each cluster comprises:
means for identifying the first document as an exemplary document within the first cluster of conceptually similar documents.

14. The computer program product of claim 12, wherein the computer readable third program code means for identifying clusters of conceptually similar documents based on the similarity measurements further comprises:
means for identifying a second document in the first subset of documents;
means for identifying a second subset of documents in the collection of documents, wherein each document in the second subset meets a similarity criterion with the second document, and wherein the similarity criterion is based on the similarity measurements; and
means for identifying a second cluster of conceptually similar documents associated with the second document if the number of documents in the second subset is at least the minimum number.

15. The computer program product of claim 14, wherein the computer readable fourth program code means for identifying at least one exemplary document within each cluster comprises means for identifying one exemplary document, the means for identifying the one exemplary document comprising:
means for assigning a score to the first cluster of conceptually similar documents associated with the first document and a score to the second cluster of conceptually similar documents associated with the second document; and
means for identifying one of the first and second documents as the one exemplary document in the cluster based on the assigned scores.

16. The computer program product of claim 12, wherein the third computer readable program code means for identifying clusters of conceptually similar documents based on the similarity measurements, further comprises:
means for identifying a second document in the collection of documents that is not associated with a cluster of conceptually similar documents;
means for identifying a second subset of documents in the collection of documents, wherein each document in the second subset meets a similarity criterion with the second document, and wherein the similarity criterion is based on the similarity measurements; and
means for identifying a second cluster of conceptually similar documents associated with the second document if the number of documents in the second subset is at least a minimum number.

17. A computer-based method for automatically reducing a number of data objects that represent information included in a collection of data objects, comprising:
generating a representation of each data object in the collection of data objects in an abstract mathematical space;
measuring a similarity between the representation of each data object in the collection of data objects and the representation of at least one other data object in the collection of data objects;
identifying clusters of conceptually similar data objects based on the similarity measurements, wherein a number of data objects in each cluster is determined based on an adjustable clustering threshold; and
identifying at least one exemplary data object within each cluster, wherein a number of identified exemplary data objects is less than a number of data objects in the collection of data objects.

18. The method of claim 17, wherein identifying clusters of conceptually similar data objects based on the similarity measurements comprises identifying each exemplary data object individually, and wherein identifying each exemplary data object comprising at least one of (i) selecting a single data object in the collection of data objects as an exemplary data object and (ii) combining a plurality of data objects in the collection of data objects into an exemplary data object.

19. The method of claim 17, wherein a data object comprises a data object expressed in at least one of a human language, a plurality of human languages, a computer language, and a plurality of computer languages.

20. The method of claim 17, wherein a data object comprises a representation of at least one of text data, image data, voice data, video data, structured data, unstructured data, and relational data.
